(19) United States
(12) Patent Application Publication
(10) Pub. No.: US 2002/0046272 A1
(43) Pub. Date: Apr. 18, 2002

(54) Central management system for peripheral apparatus

(76) Inventor: Nobuhiro Ikeda, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/977,701

(22) Filed: Oct. 16, 2001

(30) Foreign Application Priority Data
Oct. 18, 2000 (JP) 318158/2000 (PAT.

(51) Int. Cl. G06F 15/173; G03G 15/00; G06F 15/16

(52) U.S. Cl. 709/223; 709/201; 399/9

(57) ABSTRACT

A communication control device is connected by wireless communication to a central management device 103, which is connected with a management center through a communication network. The central management device stores CS identification data and PS identification data for respectively identifying the central management device itself and registered individual communication control devices. These data are also stored in a management center. In case the currently used central management device is replaced by a new central management device, the registered data are registered in the new central management device from the management center through the communication network.

### BACKGROUND OF THE INVENTION

1. Field of the Invention

The present invention relates to a management device for wireless communication with a communication control device.

2. Description of the Related Art

Recently there is being utilized a remote central management system for managing peripheral devices such as copying machines in a remote location.

FIG. 10 is a view showing the entire configuration of a conventional remote central management system for copying machines.

Plural copying machines 506a, 506b are connected through respective control devices 501a, 501b to a management device 503, which is connected by a modem 502 to a communication network 504 through a telephone line 507. A management center 505 is composed by connecting a personal computer (PC) 509 to a line control device 508, which is connected to the communication network 504 through the telephone line 507. The management center 505 manages various trouble data of the copying machine.

In this system, a trouble (paper jamming, no toner etc.) generated in the copying machines 506a, 506b is informed by the control devices 501a, 501b to the management device 503 and further informed to the management center 505 through the modem 502 by way of the telephone line 507 and the communication network 504, whereby the maintenance etc. conventionally executed by the service person can be achieved from a remote location.

Also the present applicant has already proposed a system of executing wireless connection between the control device 501a, 501b and the management device 503 in such system. An example of such wireless communication technology is PHS (personal handy-phone system).

A system utilizing the wireless communication technology can be constructed by providing the management device 503 with a master function while providing the control devices 501a, 501b with a slave function and registering the slave devices in the master management device 503.

The registration of the slave device in the master device can be achieved for example by a method shown in FIG. 11, which is a chart showing the sequence of slave device registration in the remote central management system.

The sequence chart only shows the principal messages but omits a part of the basic messages. The details are based on the standard RCRSTD-28.

At first each of the management device 503 constituting the master device and the control device 501 constituting the slave device are respectively given a function of entering a command and displaying the result of input or connected to a terminal device such as a keyboard. In the registering operation, a registration start command is entered almost simultaneously in the master device and in the slave device, whereby both shift the registration mode.

Along the sequence shown in FIG. 11, “registration start” commands are entered almost simultaneously into the master device and the slave device, whereby they respectively enter the “registration mode”.

Then, in the master device, there are entered an extension number of the slave device (assumed as “11”) and a password (assumed as “1234”) whereupon the master device transmits an informing signal for the registration mode to the slave device.

On the other hand, also in the slave device, there are entered numbers same as the “slave extension number” and the “password” entered in the master device, whereby initiated is a CS search for identifying the master device transmitting the above-mentioned informing signal for the registration mode. If such search identifies a corresponding master device, a slave data writing sequence executes a registration process after confirming the coincidence of the “slave extension number” and the “password” entered respectively in the master device and the slave device, whereby the registration of the slave device into the master device is completed.

Also in case of registering plural slave devices at the same time in the master device, there can be conceived a method of entering “slave extension number” and “password” of the plural slave devices in advance in the master device and dispensing with the input process for the registration parameter for each slave device in the master device thereby enabling registration of the slave devices in continuous manner.

FIG. 12 is a sequence chart showing the registration (continuous registration) in such remote central management system.

In case of continuous registration, the registration information (“slave extension number” and “password”) of the plural slave devices to be registered are entered in advance from a terminal device such as a PC (for example a PC 509 connected through the communication network 504) to the master device. The registration work is initiated by receiving a “registration start” command in the master device and substantially simultaneously entering the “registration start” command in the slave device to be registered first. The master device, having received the registration information (“11” (slave extension number) and “1234” (password)) of the first slave device from the parameters of the slaves devices entered in advance, transmits the information signal for the registration mode to such slave device.

On the other hand, if the slave device finds a corresponding master device in the CS search as explained in the foregoing, it confirms that the “slave extension numbers (11)” and the “passwords (1234)” entered respectively in the master device and the slave device mutually coincide in the slave data writing sequence and then executes the registration process, whereby the registration for the first slave device into the master device is completed.

After the registration of the first slave device, the initially entered registration information for the second slave device is confirmed between the master device and the PC, and the registration process is repeated in a similar manner as in the first slave device, whereby the registration is executed for the plural slave devices.

Also the management device, in the course of managing plural registered slave devices, may have to stop the function as the master device for a certain period in case of a failure for some reason or in case of maintenance.

In such case the system can be restored by replacing the management device with another management device of a same configuration and registering all the plural slave devices in the net management device.

However, in case of replacing the master device in such central management system, the operation of repeating the registration requires an enormous time and is cumbersome as the number of the slave devices to be registered increases.

### SUMMARY OF THE INVENTION

In consideration of the foregoing, an object of the present invention is to provide a central management system for the peripheral devices, capable of maintenance and restoration of the system easily in a short time.

Another object of the present invention is to provide a central management system for the peripheral devices, capable of facilitating acquisition of necessary data at the replacement by a new central management device.

Still another object of the present invention is to enable efficient acquisition of the necessary data thereby achieving maintenance and restoration of the system easily in a short time.

Still another object of the present invention is to enable maintenance and restoration of the system easily in a short time by a simple configuration.

Still other objects of the present invention, and the features thereof, will become fully apparent from the following description to be taken in conjunction with the accompanying drawings.

### BRIEF DESCRIPTION OF THE DRAWINGS

FIG. 1 is a block diagram showing the entire configuration of a central management system for peripheral devices constituting a first embodiment of the present invention;

FIG. 2 is a block diagram showing the configuration of a central management device in the first embodiment;

FIG. 3 is a view showing the data configuration in a non-volatile memory of the central management device in the first embodiment;

FIG. 4 is a block diagram showing the configuration of a communication control device in the first embodiment;

FIG. 5 is a sequence chart of a registration data transmission/reception process between a management center and a central management device in the first embodiment;

FIG. 6 is a flow chart showing a process executed in the management center in a registration data transmission/reception process in the first embodiment;

FIG. 7 is a flow chart showing a process executed in the central management device in the registration data transmission/reception process in the first embodiment;

FIG. 8 is a sequence chart of a registration data transmission/reception process between the central management device and the communication control device in a second embodiment of the present invention;

FIG. 9 is a sequence chart of a registration data transmission/reception process between the central management device and the communication control device in a third embodiment of the present invention;

FIG. 10 is a view showing the entire configuration of a conventional remote central management system for copying machines;

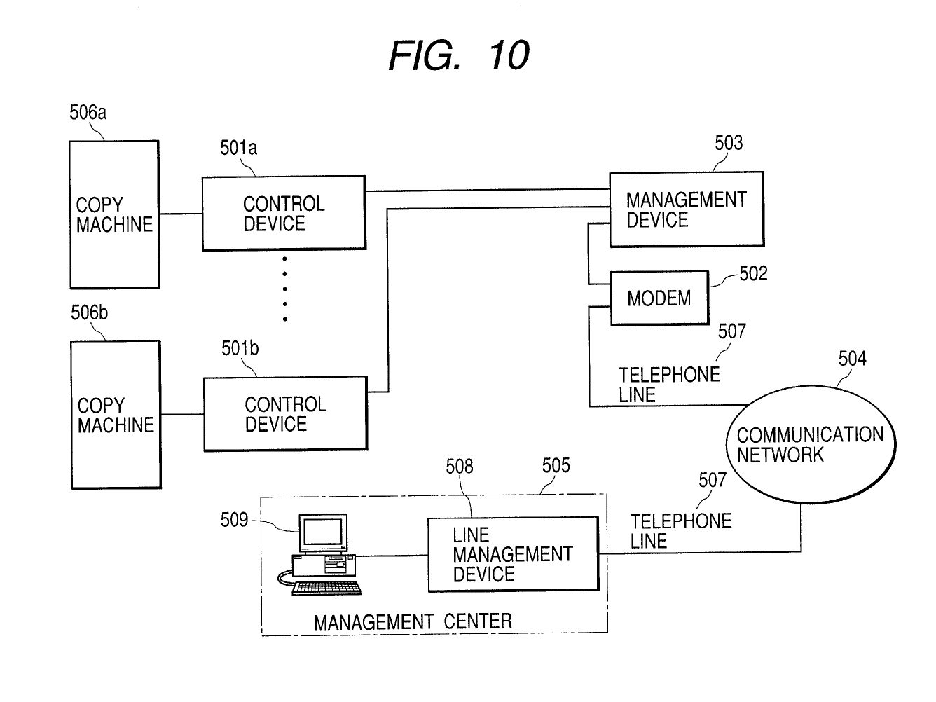

FIG. 11 is a sequence chart of registration in a remote central management system;

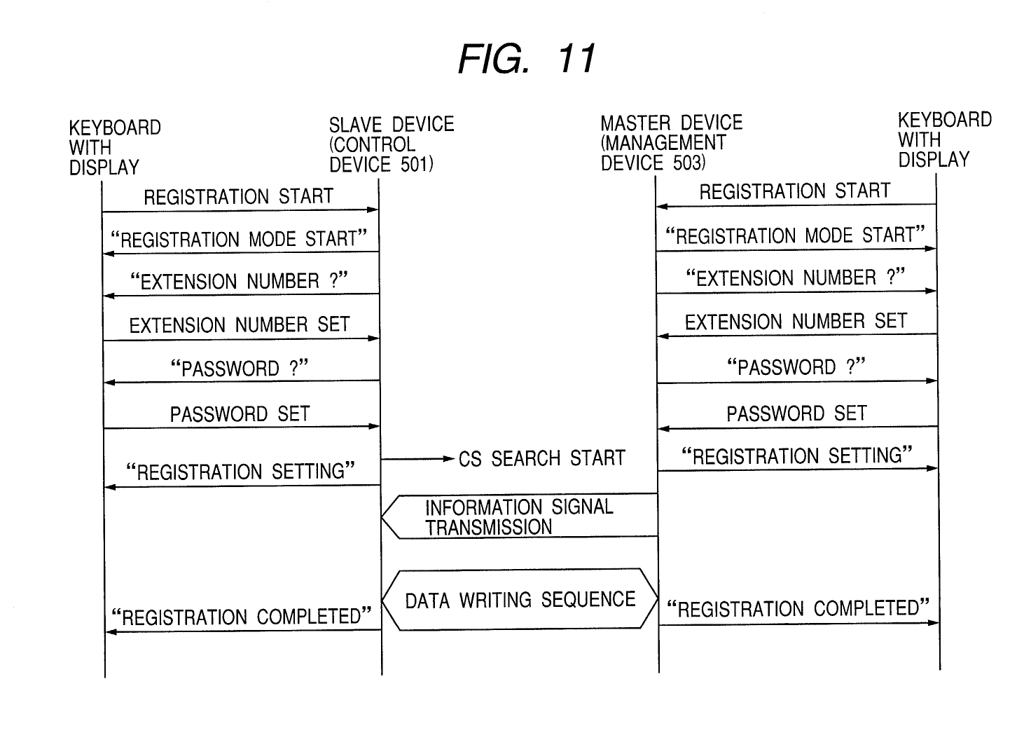

FIG. 12 is a sequence chart of registration (continuous registration) in a remote central management system; and

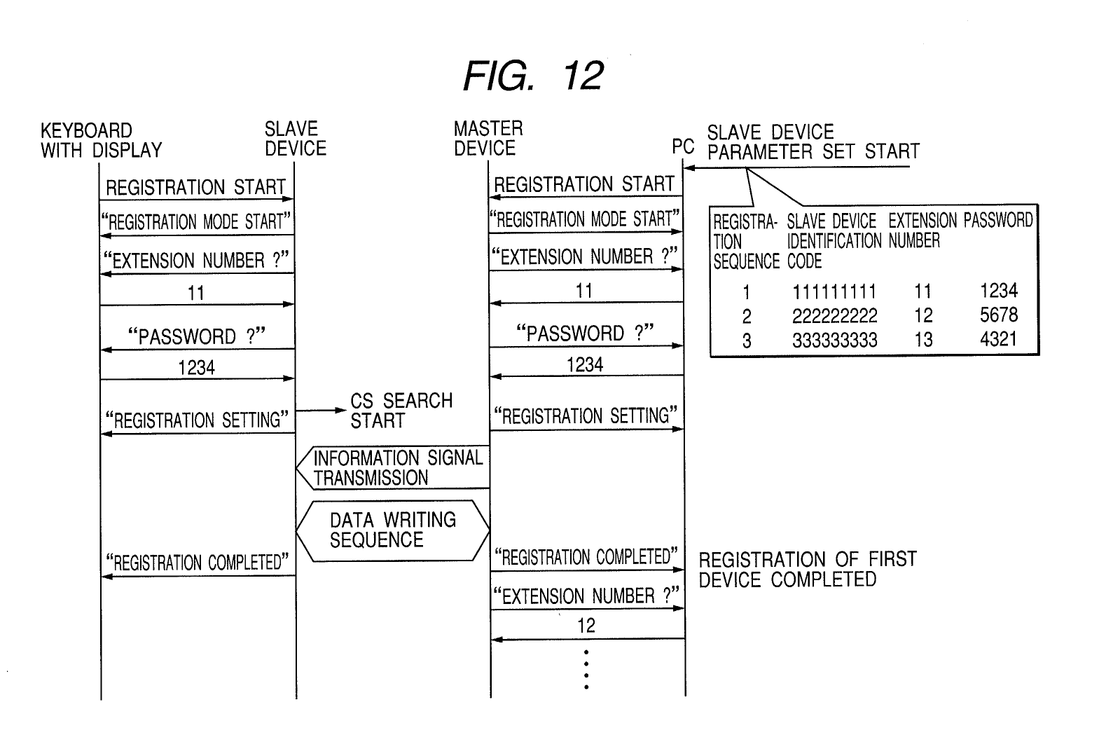

FIG. 13 is a block diagram showing the configuration of the management center.

### DETAILED DESCRIPTION OF THE PREFERRED EMBODIMENTS

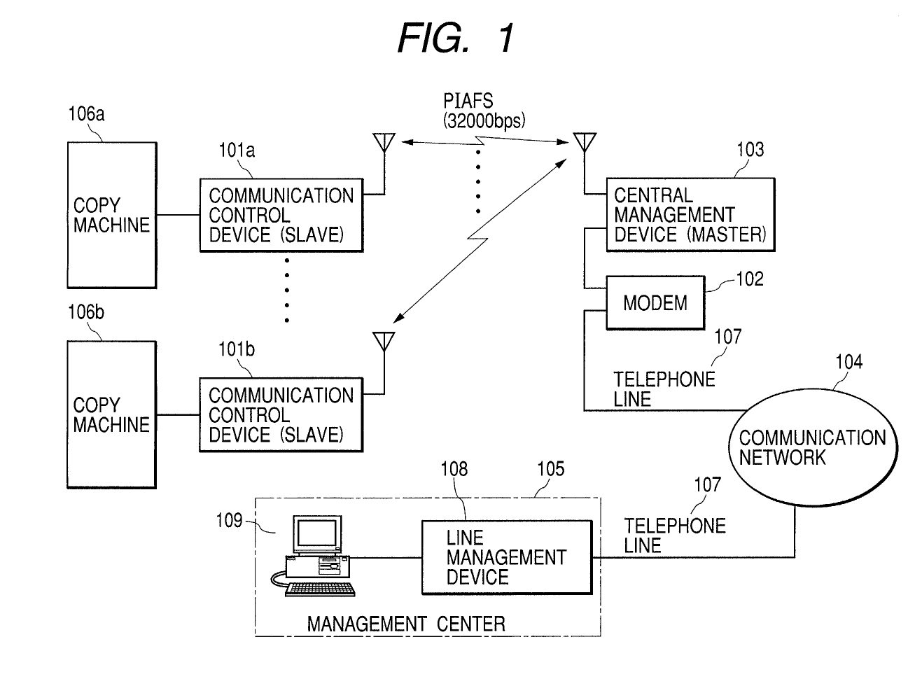

FIG. 1 is a block diagram showing the entire configuration of a central management system for peripheral device, constituting a first embodiment of the present invention.

Plural copying machines (peripheral devices) 106a, 106b are so connected as to be capable of communication with a central management device 103 by PIAFS (PHS internet access forum standard) respectively through communication control devices 101a, 101b. The central management device 103 is connected by a modem 102 to a communication network 104 through a telephone line 107.

A management center 105 is composed by connecting a personal computer (PC)109 to a line control device 108, which is connected to the communication network 104 through the telephone line 107. The plural copying machines 106a, 106b and the communication control devices 101a, 101b may also be present in three or more units.

The present system manages various trouble data of the copying machines and executes maintenance etc. In the present system, a trouble (paper jamming, no toner etc.) generated for example in the copying machine 106a is informed by the communication control device 101a to the central management device 103 utilizing the PHS wireless communication based on the PIAFS communication protocol, and is further informed to the management center 107 through the modem 102, utilizing the telephone line 107 and the communication network 104. There may also be utilized a communication protocol other than PIAFS.

In the present system, various enquiries and set data are transmitted from the management center 105 to the copying machine 106.

In order to construct the present system, all the communication control device 101a, 101b to be managed by the central management device 103 have to be registered as the slave PHS devices in the central management device 103 serving as the master PHS device.

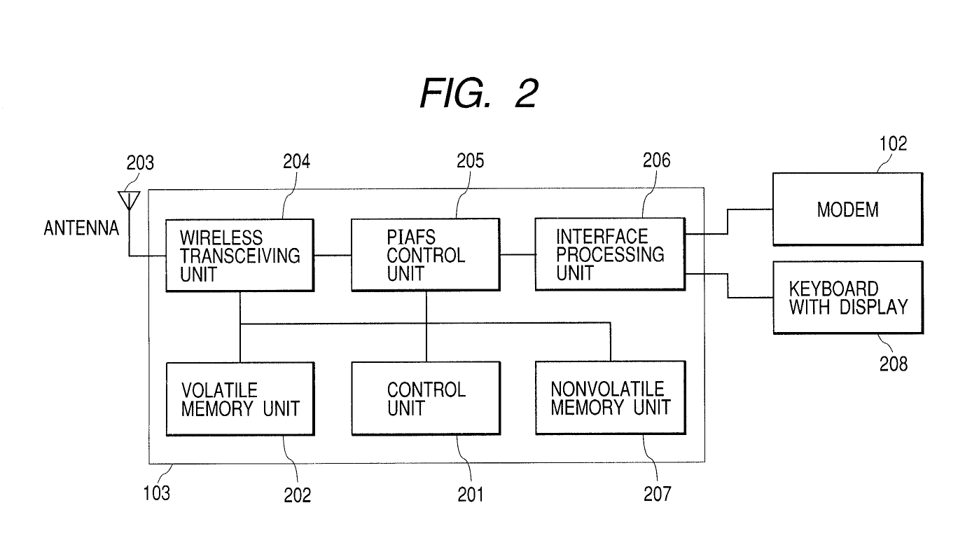

FIG. 2 is a block diagram showing the configuration of the central management device 103. In FIG. 2, there are shown the central management device 103 together with the modem 102 and a keyboard 208 with a display unit.

The central management device 103 is composed of a wireless transmission/reception unit 204, a PIAFS control unit 206, an interface processing unit 206, a volatile memory unit 202, a control unit 201 and a non-volatile memory unit 207. The control unit 201 is connected to the wireless transmission/reception unit 204, the PIAFS control unit 205, the volatile memory unit 202 and the non-volatile memory unit 207. The wireless transmission/reception unit 204, the PIAFS control unit 205 and the interface processing unit 206 are serially connected. An antenna 203 is connected to the wireless transmission/reception unit 204, and the interface processing unit 206 connects the modem 102 and the keyboard 208 with the display unit.

The wireless transmission/reception unit 204 exchanges various wireless data with the communication control devices 101a, 101b through the antenna 203. The PIAFS control unit 205 executes conversion, based on the PIAFS protocol, on the wireless data transmitted or received by the wireless transmission/reception unit 204.

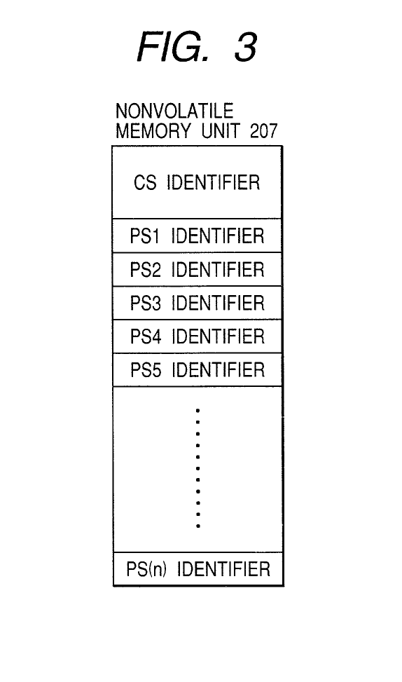

FIG. 3 shows the data configuration in the nonvolatile memory unit 207 of the central management device 103.

When the present system is operated, the plural communication control devices 101a, 101b are registered in the non-volatile memory unit 207. As the internal structure, there are provided a CS identifier (master identifying data) for identifying the central management device 103 itself, and a PS identifier (PS1 to PSn) (slave identifying data) for identifying the registered individual communication control devices 101a, 101b. In the present embodiment, there can be registered n communication control devices 101 as the slave devices.

The management center 105 identifies the central management device 103 and the plural communication control devices 101 based on the master identifying data and the slave identifying data stored in the non-volatile memory unit 207 of the central management device 103, and manages the copying machines 106 constituting the peripheral devices from a remote location through the communication network 104 and the central management device 103.

In case an abnormality such as paper jamming is generated for example in the copying machine 106a, the communication control device 101a detects such abnormality and transmits, from the wireless transmission/reception unit 404, an abnormality message including the CS identifier of the central management device 103 and the PS identifier of the communication control device 101a. Upon receiving the abnormality message by the wireless transmission-reception unit 204, the central management device 103 identifies that an abnormality has occurred in the communication control device 101a registered in the central management device 103, based on the CS identifier and the PS identifier attached to the abnormality message. Then, if necessary, it informs the management center 105 of such abnormality through the interface management unit 206 and the modem 102. The central management device 103 disregards the abnormality message if the CS identifier thereof is not the CS identifier thereof. The central management device 103 disregards the abnormality message also if the PS identifier is not a PS identifier registered in advance.

Also in case of checking the copy number (cumulative number) of the copying machine 106a, the PC 109 of the management center 105 makes a call to the communication network 104 thereby making a connection with the central management device 103 and requests the connection with the communication control device 101a to the central management device 103, designating the PS identifier of the communication control device 101a of the copying machine 106a to the central management device 103. The central management device 103 connects the wireless channel with the communication control device 101a utilizing the PS identifier of the communication control device 101a. The PC 109 of the management center 105 is connected with the communication control device 101a through the communication network 104 and the central management device 109 and receives the copy number data of the copying machine 106a from the communication control device 101a.

Also the central management device 103 may be replaced by another central management device of the same configuration in case of a failure for some reason in the course of operation of the central management device 103 under operation or in case of maintenance. In such case, since the communication control devices 101 under current operation are not registered in the new central management device, the CS identifiers and the PS identifiers, necessary for transmitting the information signal etc., have to be registered again in the new central management device after the replacement. More specifically, it is necessary to reconstruct the data structure as shown in FIG. 3 in the non-volatile memory unit of the new central management device by a suitable method.

In the present system, the data of the registered CS identifiers and PS identifiers are stored, also in the management center 105, in 1-to-1 correspondence to the number data of the telephone lines held by the central management device 103 in the communication network 104.

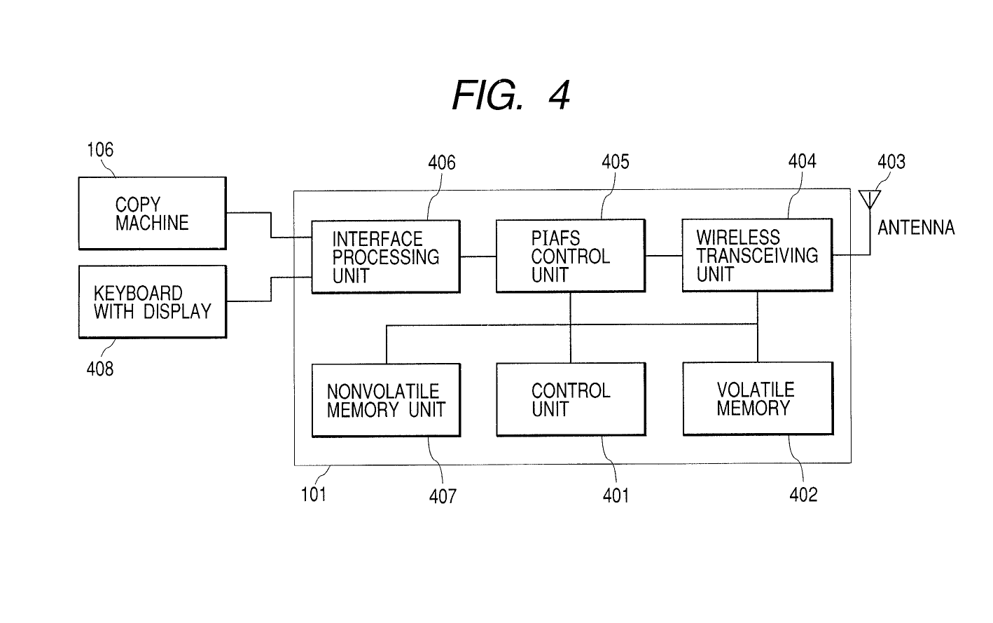

FIG. 4 is a block diagram showing the configuration of the communication control device 101, together with the copying machine 106 and the keyboard 408 with display. Such keyboard 408 with display may be a display unit and a keyboard provided in the copying machine 106.

The communication control device 101 is composed of a wireless transmission/reception unit 404, a PIAFS control unit 405, a interface processing unit 406, a volatile memory unit 402, a control unit 401 and a non-volatile memory unit 407. The control unit 401 is connected to the wireless transmission/reception unit 404, the PIAFS control unit 405, the volatile memory unit 402 and the non-volatile memory unit 407. The wireless transmission-reception unit 404, the PIAFS control unit 405 and the interface processing unit 406 are serially connected. An antenna 403 is connected to the wireless transmission/reception unit 404, and the interface processing unit 406 connects the copying machine 106 and the keyboard 408 with display.

The wireless transmission/reception unit 404 exchanges various wireless data with the central management device 103 through the antenna 403. The PIAFS control unit 405 executes conversion, based on the PIAFS protocol, on the wireless data transmitted or received by the wireless transmission/reception unit 404.

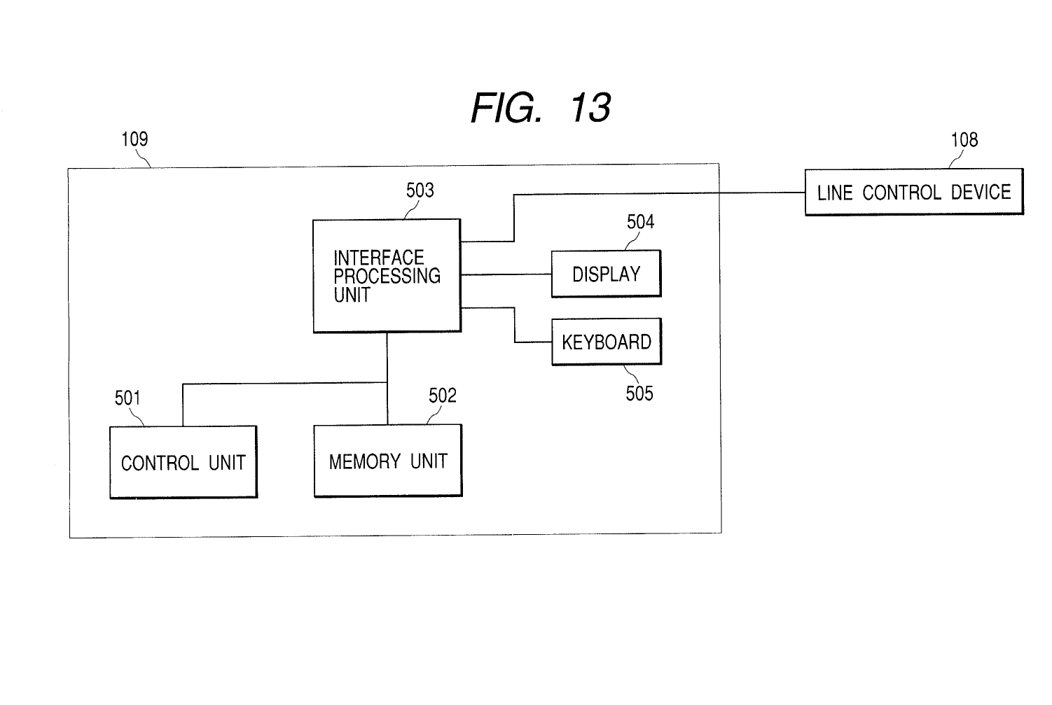

FIG. 13 is a block diagram showing the configuration of the management center 105, wherein shown are a control unit 501, a memory unit 502, an interface processing unit 503, a display 504 and a keyboard 505.

In the following there will be explained the process of replacing the central management device 103 under current use with another central management device of the same configuration (also represented as central management device 103) in case of a failure or for maintenance.

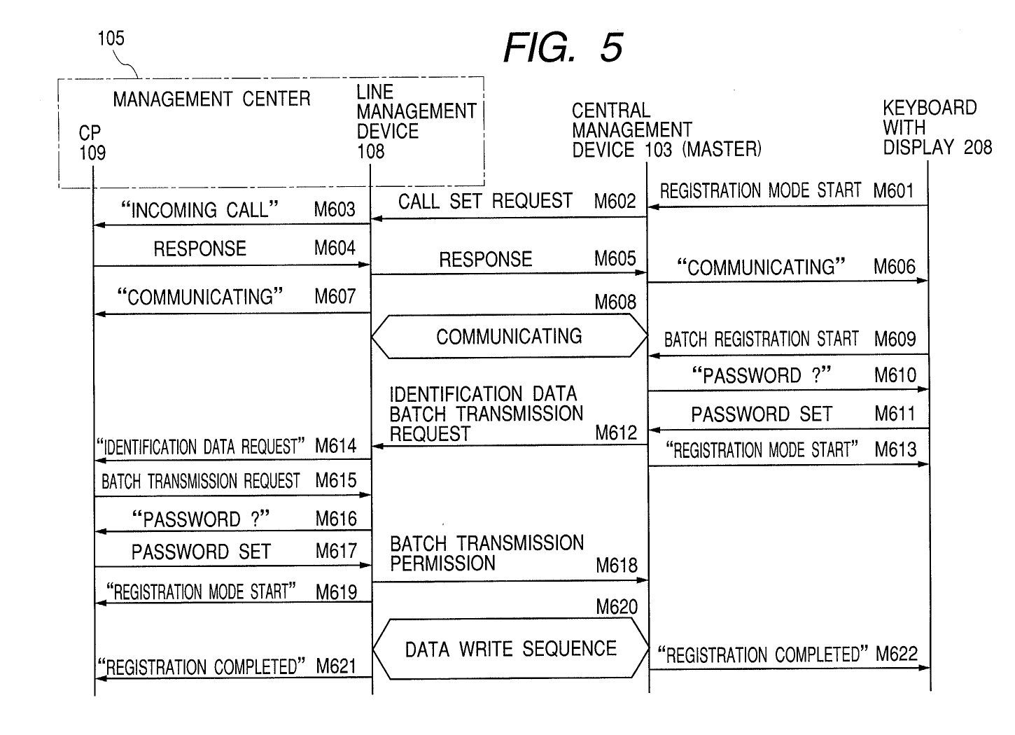

FIG. 5 is a sequence chart showing a registration data transmission/reception process to be executed between the management center 105 and the central management device 103 in the present embodiment.

The sequence chart only shows the principal messages but omits a part of the basic messages. The details are based on the standard RCRSTD-28.

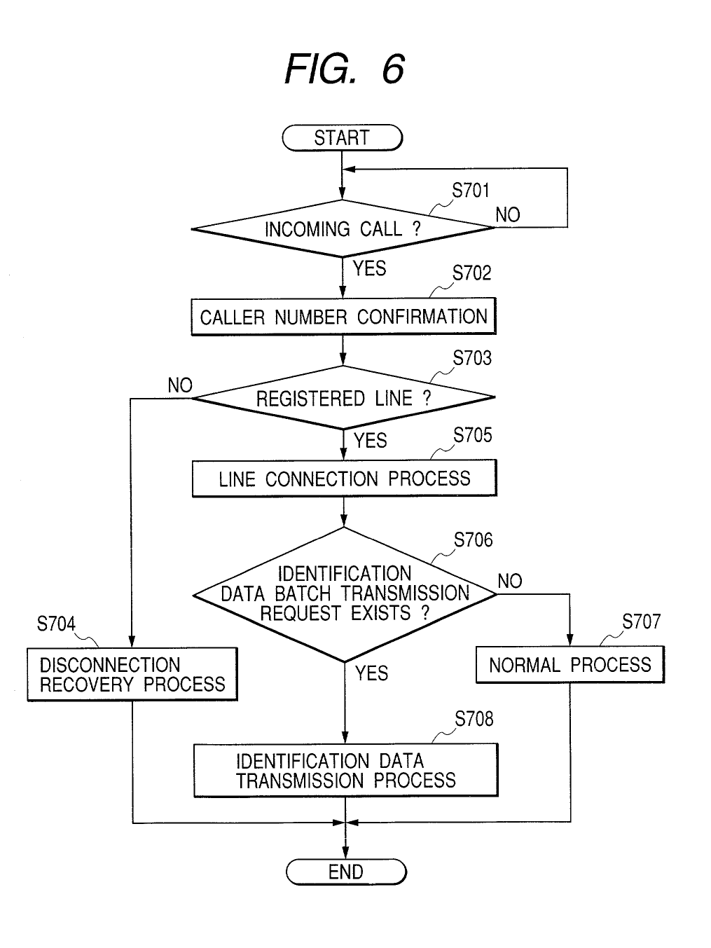

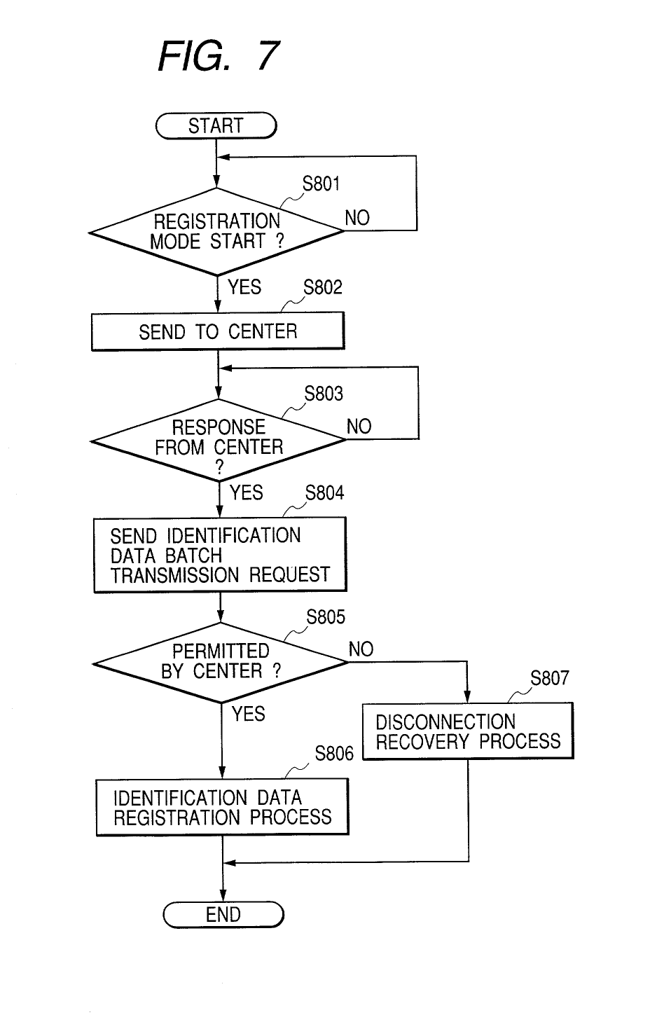

FIG. 6 is a flow chart showing a process to be executed in the management center 105 within the registered data transmission-reception process, and FIG. 7 is a flow chart showing a process to be executed in the central management device 106 within the registered data transmission/reception process. The sequence of the registration data transmission/reception process shown in FIG. 5 proceeds by parallel execution of the processes shown in FIGS. 6 and 7. In the following, the process will be explained with reference to FIGS. 5 to 7.

The central management device 103 under current use is replaced by the new central management device 103, which is then connected as the PHS master device to the modem 102.

As shown in FIG. 5, the operator manipulates the keyboard 208 with display connected to the new central management device 103 to activate the registration mode, whereby the keyboard 208 with keyboard sends a registration mode activation message M601 to the central management device 103. When the central management device 103 detects the activation of the registration mode (step S801), the central management device 103 transmits a call setting request message M602 for establishing a call to the management center 105 through the modem 102, the telephone line 107 and the communication network 104 (step S802). The call setting request message M602 includes a call number (number of the central management device 103). The call setting request message M602 is supplied through the communication network 104 to the management center 105.

Upon receiving the call setting request message M602 by the line control device 108, the management center 105 transmits a call reception message M603 to the PC 109 which stores various data such as registration data. The call reception message M603 includes a call number (number of the central management device 103).

Upon receiving the call reception message M603 (step S701), the PC 109 confirms the call number (step S702), and, if the data such as the telephone line etc. used by the partner central management device 103 is already registered in the memory unit 502 (step S703), transmits a response message M604 to the line control device 108 (step S705). In response the line control device 108 transmits a response message M605 and also transmits a communicating message M607 to the PC 109 in order to inform that it has responded to the partner and has shifted into a communicating state. The response message M605 is transferred to the central management device 103 through the communication network 104. The line connecting process is thus executed by the transmission and reception of the response messages M604, M605 and the communicating message M607.

On the other hand, upon receiving the response message M605 from the management center 105 (step S803), the central management device 103 transmits a communicating message M606 to the keyboard 208 with display in order to inform that it has received the response message M605 and has shifted into a communicating state. Thereafter the management center 105 and the central management device 103 shift into the communicating state M608.

Upon receiving the communicating message M606, the keyboard 208 with display displays the shift to the communicating state with the management center 105. The operator, in order to re-register the CS identifier and the PS identifier necessary for transmitting the information signal etc. after the replacement of the central management device 103, manipulates the keyboard 208 with display to activate the identification data registration process for the central management device 103.

At first the keyboard 208 with display transmits a collective registration start message M609 to the central management device 103. In response, the central management device 103 returns a password input message M610 requesting the input of a password to the keyboard 208 with display. Upon receiving the password input message M610, the keyboard 208 with display displays a password input image. The operator enters a password, and the keyboard 208 with display transmits a password setting message M611 to the central management device 103.

In response to the password setting message M611, the central management device 103 transmits a registration mode start message M613 to the keyboard 208 with display in order to inform the start of a collective registration mode, and also transmits an identification data collective transmission request message M612 to the management center 105 (step S804).

Having received the identification data collective transmission request message M612, the line control device 108 transmits an identification data request message M614 to the PC 109. Having received the identification data request message M614 (step S706), the PC 109 transmits a collective transmission request message M615 to the line control device 108. Having received the collective transmission request message M615, the line control device 108 returns a password input message M616, requesting the input of the password, to the PC 109. Having received the password input message M616, the PC 109 enters the password and transmits a password setting message M617 to the line control device 108.

Having received the password setting message M617, the line control device 108 transmits a collective transmission permitting message M618 to the central management device 103 in order to inform that the request for the collective registration has been received, and also transmits a registration mode start message M619 to the PC 109 in order to inform that the collective registration mode has been started.

Thereafter the management center 105 executes a transmission process of transmitting the identification data memorized in the memory unit 502 (step S708), and the central management device 103 executes a registration process of registering the received identification data in the non-volatile memory unit 207 (step S806). The transmission process in the management center 105 and the registration process in the central management device 103 are respectively executed employing a data writing sequence M620. More specifically, the registration data transferred from the management center 105 are stored in the non-volatile memory unit 207 of the new central management device 103, whereby the data as shown in FIG. 3 are reconstructed and the system is thus restored.

When the registration process is completed by the data writing sequence M620, registration success messages M621, M622 are respectively transmitted from the line control device 108 to the PC 109 and from the central management device 103 to the keyboard 208 with display, thereby informing the completion of the collective registration process.

In the following, the aforementioned process will be viewed from the side of the management center 105 with reference to FIG. 6.

At first there is discriminated whether an incoming call has been received, namely whether an incoming call message M603 has been received by the PC 109 (step S701). The discrimination is continued until an incoming call is received, and, in case the PC 109 receives the incoming call message M603, the PC 109 confirms the call number (step S702) and discriminates whether the data for example of the telephone line used by the partner central management device 103 are already registered in the memory unit 502 (step S703). If the discrimination identifies that the data are not yet registered, there is executed a disconnection/restoration process (step S704) whereupon the present process is terminated. On the other hand, if the data are already registered, there is executed the aforementioned line connecting process (transmission/reception of the response message M604 and the communicating message M607) (step S705).

Then there is discriminated whether the identification data collective transmission request message M612 has been received from the central management device 103 (step S706). If the discrimination identifies that the identification data collective transmission request message M612 has been received from the central management device 103, the line control device 108 executes transmission process for the identification data memorized in the memory unit 502 of the PC 109, utilizing the data writing sequence M620 (step S708), whereupon the present process is terminated. On the other hand, if the identification data collective transmission request message M612 is not received from the central management device 103 (for example in case of receiving an ordinary request message for various data), there is executed an ordinary process different from the process of the registration mode (step S707), whereupon the present process is terminated.

Now the aforementioned process will be viewed from the side of the central management device 103, with reference to FIG. 7.

At first there is discriminated whether the activation of the registration mode has been detected (step S801). The discrimination is continued until the activation of the registration mode is detected, and, when the activation of the registration mode is detected, there is transmitted a call setting request message M602 for establishing a call to the management center 105 (step S802). Then there is discriminated whether the response message M605 has been received from the management center 105 (step S803). The discrimination is repeated until the response message M605 is received, and, when the response message M605 is received, the identification data collective transmission request message M612 is transmitted to the management center 105 (step S804).

Then there is discriminated whether the collective transmission permitting message M618 has been received from the management center 105 (step S805). If the discrimination identifies that the collective transmission permitting message M618 has been received, the identification data registration process is executed utilizing the data writing sequence M620 to reconstruct the data as shown in FIG. 3 in the non-volatile memory unit 207 of the new central management device 103 (step S806) whereupon the present process is terminated.

On the other hand, if the collective transmission permitting message M618 has not been received, the collective registration process from the management center 105 is not permitted, so that the disconnection/restoration process is executed (step S807) whereupon the present process is terminated.

According to the present embodiment, in case the currently used central management device 103 is replaced by another central management device because of a failure or for maintenance, the registration data (CS identifiers and PS identifiers) stored in the management center 105 are transferred to the new central management device 103 to reconstruct the data shown in FIG. 3 in the non-volatile memory unit 207, so that the registration process can be completed within a short time even if there are many communication control devices 101 to be registered. Thus, in the replacement to the new central management device, the acquisition of the registration data can be facilitated to achieve maintenance and restoration of the system easily within a short time.

Also the transfer and writing of the registration data (CS identifiers, PS identifiers) are executed collectively for all the communication control devices 101, so that the acquisition of the registration data can be executed in efficient manner to achieve maintenance and restoration of the system easily within a short time.

Also the new central management device 103 may acquire the PS identifier and the CS identifier from a specified communication control device 101 instead of the management center 105. Therefore, such embodiment is similar to the first embodiment in the basic configuration but is different therefrom in the registration data transmission/reception process.

Such second embodiment of the present invention will be explained with reference to FIGS. 1 to 4 and 8.

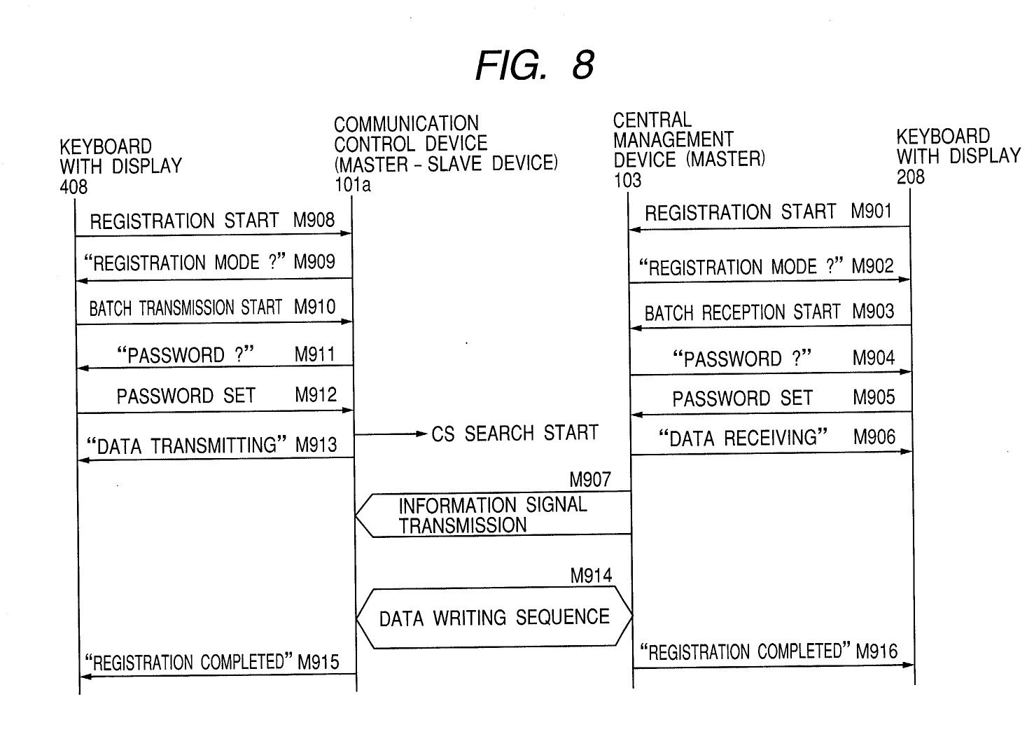

FIG. 8 is a sequence chart showing the registration data transmission/reception process executed between the central management device 103 and the communication control device 101a in the present embodiment.

The communication control device 101a used in the present sequence is, among the plural communication control devices 101, a particular communication control device holding in advance the identification data (FIG. 3) of the PS identifiers of all the communication control devices 101 and the CS identifier of the central management device 103, and is called a master slave device.

The communication control device 101a, constituting the master slave device, stores, in the non-volatile memory unit 407, the PS identifiers of the slave devices registered in the central management device (master device) 103 and the CS identifier of the central management device 103. In case a communication control device 101b other than the communication control device 101a is registered in the central management device 103, the communication control device 101a stores, in the non-volatile memory unit 407, the PS identifiers of such communication control device 101b other than the communication control device 101a.

The communication control device 101a serving as the master slave device (hereinafter called “master communication control device”) can be arbitrarily selected and stores the PS identifiers and the CS identifier in the non-volatile memory unit 407. There may also be provided two or more master communication control devices 101.

In case the currently used central management device 103 is replaced by another central management device of the same configuration for some reason, the new central management device 103 is connected as the master PHS device to the modem 102. The process thereafter is executed according to the sequence chart of the registration data transmission/reception process shown in FIG. 8. In order to execute the present sequence, the central management device 103 and the master communication control device 101a respectively execute predetermined processes as in the first embodiment.

At first, in order to establish the registration mode between the central management device 103 and the master communication control device 101a, a registration start message M901 is transmitted from the keyboard 208 with display connected to the central management device 103 to the central management device 103. Having received the registration start message M901, the central management device 103 returns a registration mode input message M902, requesting the input of the registration mode, to the keyboard 208 with display.

Having received the registration mode input message M902, the keyboard 208 with display transmits a collective reception start message M903 to the central management device 103. Having received the collective reception start message M903, the central management device 103 returns a password input message M904, requesting the input of the password, to the keyboard 208 with display, which, in response, displays a password input image. When the operator enters the password, the keyboard 208 with display transmits a password setting message M905 to the central management device 103.

Having received the password setting message M905, the central management device 103 transmits a registration data receiving message M906 to the keyboard 208 with display in order to inform that the collection registration mode has been started, and also transmits an information signal M907 for registration from the wireless transmission/reception unit 204 to the master communication control device 101a. Thus the sequence enters a waiting state for waiting for a response from the master communication control device 101a.

On the other hand, in order that the master communication control device 101a can shift to the registration mode independently from the central management device 103, a registration start message M908 is transmitted from the keyboard 408 with display to the master communication control device 101.

Having received the registration start message M908, the master communication control device 101a returns a registration mode input message M909, requesting the input of the registration mode, to the keyboard 408 with display. Having received the registration mode input message M909, the keyboard 408 with display transmits a collection reception start message M910 to the master communication control device 101a. Having received the collective reception start message M910, the master communication control device 101a returns a password input message M911, requesting the input of the password, to the keyboard 408 with display, which in response displays a password input image. When the operator enters the password, the keyboard 408 with display transmits a password setting message M912 to the master communication control device 101a.

Having received the password setting message M912, the master communication control device 101a transmits a registration data receiving message M913 to the keyboard 408 with display in order to inform the start of the collective registration mode and initiates the CS search on the information signal for registration informed from the central management device 103.

In case the CS search utilizing the wireless transmission-reception unit 404 identifies the information signal M907 for registration in the master communication control device 101a, the master communication control device 101a executes transmission process of the identification data memorized in the non-volatile memory unit 407 after the establishment of the wireless channel. Also the central management device 103 executes a process of registering the identification data, transmitted from the master communication control unit 101a, in the non-volatile memory unit 207. The transmission process of the identification data in the master communication control device 101a and the registration process of the identification data in the central management device 103 are respectively executed by the data writing sequence M914, thereby reconstructing the data as shown in FIG. 3 in the non-volatile memory unit 207 of the new central management device 103.

When the registration process by the data writing sequence M914 is completed, registration success messages M915, M916 are respectively transmitted from the master communication control device 101a to the keyboard 408 with display and from the central management device 103 to the keyboard 208 with display, thereby informing the completion of the collective registration process.

The present embodiment provides effects similar to those in the first embodiment, with respect to the registration in the new central management device. Also the configuration is not complicated because the master communication control device 101a is specified and the PS and CS identifiers stored therein are transferred to the new central management device 103. It is therefore rendered possible to easily achieve maintenance and restoration of the system with a simple configuration and within a short time.

The communication between the specified communication control device 101aand the central management device 103 may also be executed in a slave-to-slave direction communication mode in the wireless PHS data communication. Therefore, such embodiment is similar to the first and second embodiments in the basic configuration but is different therefrom in the registration data transmission/reception process.

Such third embodiment of the present invention will be explained with reference to FIGS. 1 to 4 and 9.

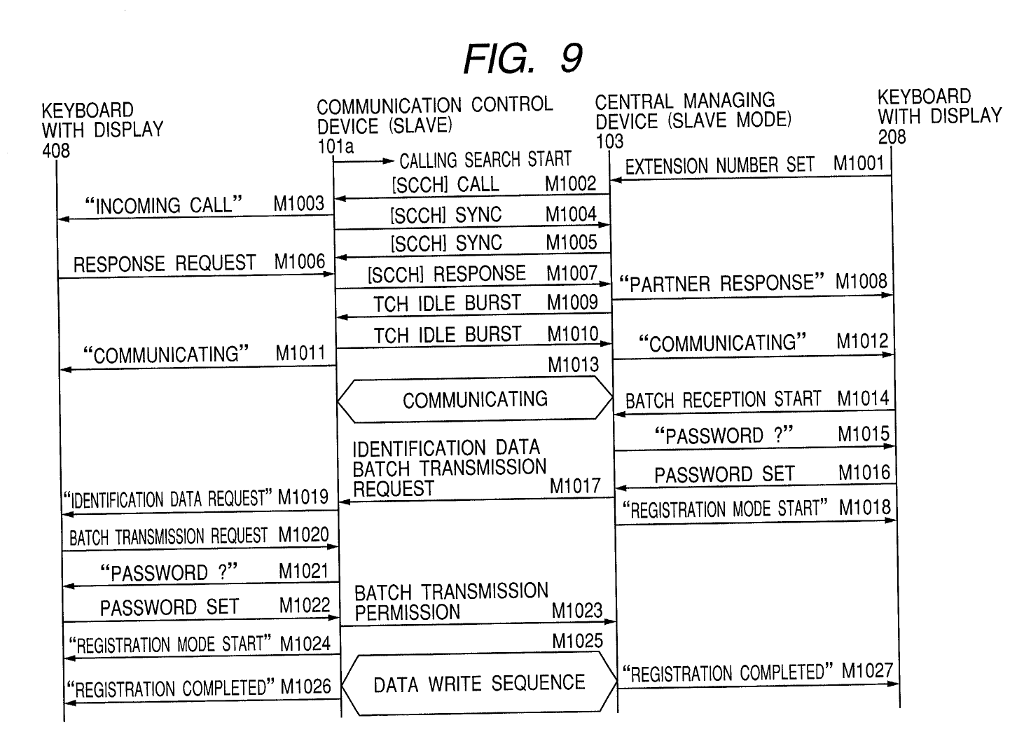

FIG. 9 is a sequence chart showing the registration data transmission/reception process executed between the central management device 103 and the communication control device 101a in the present embodiment.

As in the second embodiment, the communication control device 101a used in the present sequence is, among the plural communication control devices 101, a particular communication control device holding in advance the identification data (FIG. 3) of the PS identifiers of all the communication control devices 101 and the CS identifier of the central management device 103, and is called a master slave device. The communication control device 101a, constituting the master slave device (hereinafter called “master communication control device 101”), can be arbitrarily selected and stores, in the non-volatile memory unit 407, the PS and CS identifiers. There may also be provided two or more master communication control devices 101.

In case the currently used central management device 103 is replaced by another central management device of the same configuration for some reason, the new central management device 103 is shifted to a slave mode and the process thereafter is executed according to the sequence chart of the registration data transmission/reception process shown in FIG. 9. In order to execute the present sequence, the central management device 103 and the master communication control device 101a respectively execute predetermined processes as in the first and second embodiments.

At first, in order to establish an extension-to-extension call to the master communication control device 101a from the new central management device 103, the operator enters, from the keyboard 208 with display connected thereto, the extension number of the master communication control device 101a thereby transmitting an extension number setting message M1001 from the keyboard 208. The central management device 103 transmits a SCCH call message M1002 in order to establish a call to the master communication control device 101a. The call message M1002 includes the extension number of the master communication control device 101a.

The master communication control device 101a, having started a call search in advance, upon receiving the call message M1002 including the extension number of the device 101a, transmits a SCCH synchronization message to the keyboard 408 with display connected to the master communication control device 101a and also exchanges SCCH synchronization messages with the central management device 103, thereby establishing a synchronization mode.

On the other hand, having received an incoming call message M1003, the keyboard 408 with display transmits a response request message M1006 to the master communication control device 101a. Having received the response request message M1006, the master communication control device 101a transmits a SCCH response message M1007 to the central management device 103 and also exchanges TCH idle burst messages M1009, M1010 with the central management device 103, thereby establishing a TCH synchronization mode. Also the keyboard 408 with display transmits a communicating message M1011 to the keyboard 408 with display in order to inform the shift to the communicating state.

Having received the response message M1007 from the master communication control device 101a, the central management device 103 exchanges the TCH burst messages M1009, M1010 with the master communication control device 101a to establish the TCH synchronization mode, and transmits a communicating message M1012 to the keyboard 208 with display in order to inform the shift to the communicating state. Thereafter the master communication control device 101la and the central management device 103 shift to a communicating state M1013.

Having received the communicating message M1012, the keyboard 208 with display activates an identification data registering process in the master communication control device 101, in order to re-register the CS and PS identifiers. More specifically, at first a collective reception start message M1014 is transmitted to the central management device 103. Having received the collective reception start message M1014, the central management device 103 returns a password input message M1015 for requesting the input of the password to the keyboard 208 with display, which in response displays a password input image. When the operator enters the password, the keyboard 208 with display transmits a password setting message M1016 to the central management device 103.

Having received the password setting message M1016, the central management device 103 transmits a registration mode start message M1018 to the keyboard 208 with display in order to inform the start of the collective registration mode, and also transmits an identification data collective transmission request data M1017 to the master communication control device 101a. Having received the identification data collective transmission request message M1017, the master communication control device 101a transmits an identification data request message M1019 to the keyboard 408 with display. Having received the identification data request message M1019, the keyboard 408 with display transmits a collective transmission request message M1020 to the master communication control device 101.

Having received the collective transmission request message M1020, the master communication control device 101a returns a password input message M1021, requesting the input of the password, to the keyboard 408 with display,, which in response displays a password input image. When the operator enters the password, the keyboard 408 with display transmits a password setting message M1022 to the master communication control device 101a.

Having received the password setting message M1022, the master communication control device 101a transmits a collective transmission permitting message M1023 to the central management device 103 in order to inform the acceptance of the request for collective registration, and also transmits a registration mode start message M1024 to the keyboard 408 with display, in order to inform the start of the collective registration mode.

Thereafter the master communication control device 101a executes a transmission process for transmitting the identification data, memorized in the non-volatile memory unit 407, from the wireless transmission/reception unit 404. The central management device 103 executes a registration process for registering the identification data, received by the wireless transmission/reception unit 204, in the non-volatile memory unit 207. The transmission process in the master communication control device 101a and the registration process in the central management device 103 are respectively executed according to a data writing sequence M1025, thereby reconstructing the data as shown in FIG. 3, in the non-volatile memory unit 207 of the new central management device 103.

When the registration process by the data writing sequence M1025 is completed, registration success messages M1026, M1027 are respectively transmitted from the master communication control device 101a to the keyboard 408 with display and from the central management device 103 to the keyboard 208 with display, thereby informing the completion of the collective registration process.

On the other hand, in case the collective transmission permitting message M1023 is not transmitted to the collective management device 103, namely in case the collective registration process is not permitted, the central management device 103 activates a disconnection/restoration process.

The present embodiment provides effects similar to those in the second embodiment. Also the configuration can be further simplified since the slave-to-slave direct communication mode in the wireless PHS data communication is employed between the new central management device 103 and the master communication control device 101.

Also the new central management device 103 may acquire the PS and CS identifiers from the non-volatile memory unit 207 of the central management device 103 prior to the replacement. In the present embodiment, there is provided unrepresented detaching means so as that the non-volatile memory unit 207 can be detached from or attached to the central management device 103. Other configurations are similar to those shown in FIGS. 1 to 4. The non-volatile memory unit 207 is advantageously constructed by a hard disk or a ROM, but such configuration is not restrictive.

In the present embodiment, in case the currently used central management device 103 is replaced by another central management device of the same configuration for some reason, the non-volatile memory unit 207 is detached, with the CS and PS identifiers stored therein, from the central management device 103 prior to the replacement and is attached to the new central management device 103. The new central management device 103 can immediately utilize the CS and PS identifiers stored in thus attached non-volatile memory unit 207, whereby the system can be restored.

The control unit 201 executes the wireless communication with the specified communication control device 101, utilizing the CS and PS identifiers stored in the attached non-volatile memory unit 207.

The present embodiment provides effects similar to those in the first embodiment, with respect to the registration in the new central management device.

The foregoing embodiments have been explained by a remote management system based on the PHS communication, but such configuration is not restrictive and they are applicable to any wireless telephone system consisting of plural slave devices and a master device capable of registering and connecting such slave devices, regardless whether the process signal is analog or digital. Also the embodiments can be subjected to various modifications within the scope of the present invention.

Also the peripheral device has been exemplified by the copying machine 106, but such example is not restrictive and the present invention is applicable to any device requiring remote control.

In the first to third embodiments, both the CS and PS identifiers are downloaded from the management center 105 or the master communication control device 101, but they have respectively different transmission sources such as downloading the CS identifier from the management center 105 and downloading the PS identifiers from the master communication control device 101.

The objects of the present invention can be realized also by supplying the central management device 103, the management center 105 and the communication control device 101 with a memory medium storing program codes of a software realizing the functions of the aforementioned embodiments and by reading and executing the program codes stored in the memory medium by computers (or CPU or MPU) of such devices.

In such case, the program codes themselves read from the memory medium realize the novel functions of the present invention, and the memory medium storing such program codes constitutes the present invention.

The memory medium for supplying the program codes can be, for example, a floppy disk, a hard disk, an optical disk, a magnetooptical disk, a CD-ROM, a CD-R, a magnetic tape, a non-volatile memory card or a ROM.

Also, the present includes not only a case where the computer executes the read program codes thereby realizing the functions of the aforementioned embodiments but also a case where an operating system or the like functioning on the computer executes all the processes or a part thereof under the instruction of such program codes thereby realizing the functions of the aforementioned embodiments.

The present invention further includes a case where the program codes read from the memory medium are once stored in a function expansion board inserted into the computer or a function expansion unit connected thereto and a CPU or the like provided in such function expansion board or function expansion unit executes all the processes or a part thereof under the instruction of such program codes, thereby realizing the functions of the aforementioned embodiments.

What is claimed is:

1. A management device comprising:
wireless communication means for wireless communication with a communication control device;
memory means for storing identification data for identifying said communication control device;
reception means for receiving data from a management center connected through a communication network; and
registration means for registering, in said memory means, the identification data received by said reception means, for identifying said communication control device.

2. A management device according to claim 1, wherein said wireless communication means executes communication for managing, by said management center, a peripheral device connected to said communication control device.

3. A management device according to claim 1, wherein said registration means registers, in said memory means, identification data received by said reception means for identifying said management device.

4. A management device according to claim 1, wherein said wireless communication means functions as a base wireless station for said communication control device functioning as a mobile wireless station.

5. A management device according to claim 1, wherein said registration means registers, in said memory means, identification data for identifying plural communication control devices connected by said reception means.

6. A management center comprising:
connection means for connecting a management device through a communication network;
memory means for storing identification data of a communication control device executing wireless communication with said management device; and
registration means for registering, in said management device, identification data of said communication control device stored in said memory means.

7. A management device comprising:
wireless communication means for wireless communication with plural communication control devices;
memory means for storing identification data for identifying said plural communication control devices;
connection means for connecting a management center through a communication network; and
registration means for registering, in said memory means, identification data received by said wireless communication means from one of said plural communication control device, for identifying said plural communication control devices.

8. A management device according to claim 7, wherein said registration means registers identification data received by interslave communication by said wireless communication means, from one of said plural communication control devices, for identifying said plural communication control devices.

9. A communication control device comprising:
wireless communication means for executing wireless communication with a management device;
memory means for storing identification data of another communication control device executing wireless communication with said management device; and
registration means for registering, in said management device, identification data of another communication control device stored in said memory means;
wherein said wireless communication means executes communication with a management center connected with said management device through a communication network.

10. A communication control device according to claim 9, wherein said registration means registers, in said management device, identification data of another communication control device stored in said memory means, in response to an information signal from said management device.

11. A management device comprising:
wireless communication means for wireless communication with a communication control device;
mounting means for detachably mounting a memory; and
connection means for connecting with a management center through a communication network;
wherein said wireless communication means communicates with said communication control device according to identification data of the communication control device stored in the memory mounted on said mounting means.
